(19) United States
(12) Patent Application Publication
(10) Pub. No.: US 2018/0227024 A1
(43) Pub. Date: Aug. 9, 2018

(54) Method and Apparatus of Beam Recommendation in Communication Systems

(71) Applicant: Futurewei Technologies, Inc., Plano, TX (US)

(72) Inventors: Pengfei Xia, San Diego, CA (US); Bin Liu, San Diego, CA (US); Richard Stirling-Gallacher, San Diego, CA (US)

(21) Appl. No.: 15/424,531

(22) Filed: Feb. 3, 2017

(51) Int. Cl. H04B 7/06; H04L 27/26

(52) U.S. Cl. CPC H04B 7/063; H04L 27/2613; H04B 7/0632; H04B 7/0617

(57) ABSTRACT

A method and system for beam recommendation in communication systems is provided. In an embodiment, a method in a device for adjusting beam parameters at a remote transmitter includes measuring, by the device, device environmental parameters. The method also includes determining, by the device, beam recommendation information according to the device environmental parameters. The method also includes transmitting, by the device, the beam recommendation information to the remote transmitter, wherein the remote transmitter uses the beam recommendation information to adjust the beam width for transmissions to the device.

### TECHNICAL FIELD

The present disclosure relates generally to a system and method wireless communication, and, in particular embodiments, to a system and method for beamforming a beam recommendations.

### BACKGROUND

Millimeter Wave (mmWave) wireless communications have been proposed for 5G new radio (NR) standards. However, mmWave communications suffer from an insufficient link budget problem. mmWave communications typically have large propagation loss that is inversely proportional to the carrier frequency. A larger carrier frequency leads to a larger propagation loss. The larger propagation loss leads to lower received signal-to-noise-ratio (SNR) and, consequently, lower or insufficient link budgets. Several potential solutions to this problem have been proposed. These potential solutions include spatial domain transmit/receive beamforming (BF), time domain spreading, and frequency domain spreading. The most popular of these potential solutions is spatial domain transmit/receive BF.

Spatial domain transmit/receive BF takes advantage of very small wavelengths. For example, consider a 30 GHz carrier frequency with a 10 millimeter (mm) wavelength. It is possible to integrate a large number of antenna elements in a small area. For example, in one configuration, it is possible to integrate 64 antenna elements (an 8×8 uniform planar array) with each side of the being around 3.5 centimeters (cm) in length. This size means that it is possible to include such antenna arrays in many handheld devices.

When using spatial domain transmit/receive BF, it is usually desirable to have a large beamforming gain at the transmitter side. This results in the formation of a small-width beam. However, when a mobile device is the receiver, a small beam width may not be desirable because the communication link is very sensitive to environmental and mobile device factors that may result in loss of data or otherwise poor performance. For example, if the spatial orientation of the mobile device is changed or the mobile device moves, it may no longer be able to receive data from the transmitter due to the narrowness of the beam.

### SUMMARY

In accordance with an embodiment, a method in a device for adjusting beam parameters at a remote transmitter includes measuring, by the device, device environmental parameters. The method also includes determining, by the device, beam recommendation information according to the device environmental parameters. The method also includes transmitting, by the device, the beam recommendation information to the remote transmitter, wherein the remote transmitter uses the beam recommendation information to adjust the beam width for transmissions to the device.

In accordance with another embodiment, a device includes a processor and a computer readable storage medium storing programming for execution by the processor. The programming includes instructions for measuring device environmental parameters. The programming also includes instructions for determining beam recommendation information according to the device environmental parameters. The programming also includes instructions for transmitting the beam recommendation information to the remote transmitter, wherein the remote transmitter uses the beam recommendation information to adjust the beam width for transmissions to the device.

In accordance with another embodiment, a non-transitory computer-readable medium storing computer instructions encoding an image, that when executed by one or more processors, cause the one or more processors to perform a plurality of steps is provided. The steps include measuring device environmental parameters. The steps also include determining beam recommendation information according to the device environmental parameters. The steps also include transmitting the beam recommendation information to the remote transmitter, wherein the remote transmitter uses the beam recommendation information to adjust the beam width for transmissions to the device.

In an embodiment, the beam recommendation information includes a recommended beam width. In an embodiment, the method, device, or computer readable storage medium includes the step of or instructions for receiving a plurality of options for a beam width, wherein the determining, by the device, beam recommendation information according to the device environmental parameters comprises selecting on of the options for the beam width. In an embodiment, the plurality of options for the beam width are received from the remote transmitter. In an embodiment, the determining beam recommendation information includes selecting a beam width corresponding to a hierarchical beam book. In an embodiment, the environmental parameters include at least one of rotation of the device, translational movement of the device, received channel quality, movement of objects proximate to the device that affect a beam signal to the device from the remote transmitter. In an embodiment, the beam recommendation information includes measured environmental parameters from which the remote transmitter determines a beam width. In an embodiment, the device is a mobile device.

In an embodiment, a method in a device for adjusting resource settings at a remote transmitter includes receiving, at the device, configuration information from a remote transmitter, the configuration information comprising multiple resource settings. The method also includes configuring the device according to the multiple resource settings. The method also includes measuring, by the device, device environmental parameters. The method also includes determining, by the device, a particular resource settings that fits best within the current channel/environment. The method also includes transmitting, by the device, the resource setting recommendation to the remote transmitter. In an embodiment, the resource settings include configuration of reference signals from the remote transmitter. In an embodiment, configuration of reference signals includes a precoder setting of the reference signal and time/frequency/code/sequence/antenna port setting of the reference signal. In an embodiment, the device is a mobile device.

In an embodiment, a device includes a processor and a computer readable storage medium storing programming for execution by the processor. The programming includes instructions for receiving multiple resource configurations from a remote transmitter. The programming also includes instructions for measuring mobile device environmental parameters. The programming also includes instructions for determining, by the mobile device, a particular resource settings that fits best within the current channel/environments. The programming also includes instructions for transmitting, by the mobile device, the resource setting recommendation to the remote transmitter. In an embodiment, the resource settings comprise configuration of reference signals from the remote transmitter. In an embodiment, the configuration of the reference signals comprises at least one of precoder setting of the reference signal or time/frequency/code/sequence/antenna port setting of the reference signal. In an embodiment, the device is a mobile device.

One or more embodiments of the disclosed methods and systems enable user equipment (UEs), i.e., mobile devices, to request and/or negotiate a desired tradeoff between the beamforming gain and the beamforming robustness based on first hand information and/or measurements that are available to the UEs, but may not be available to the transmitter. Additionally, one or more embodiments enable the transmit and receive point (TRP) to understand the sensitivity requirements on the UE side and thereby allow the TRP to adapt its beamforming to compensate for the changing environments experienced by the UE due to, for example, the movement of the mobile device or others in the environment. Furthermore, embodiments of the disclosed systems and methods enable robust reception at the receiver side of a wireless communication system.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of a UE illustrating translational movement of the UE;

FIG. 2 is a diagram of the UE illustrating rotational movement of the UE;

FIG. 3 is a block diagram of an embodiment of a method for adjusting beam width according to UE recommendations;

FIG. 4 is a diagram illustrating fine and course beams;

FIG. 5 is a flowchart illustrating an embodiment of a method in a UE for recommending a new beam width to a TRP;

FIG. 6 is a flowchart of an embodiment of a method in a TRP for adjusting beam forming parameters based on recommendations from the UE;

FIG. 7 is a block diagram of a UE;

FIG. 8 is a block diagram of a TRP;

FIG. 9 illustrates a block diagram of an embodiment processing system for performing methods described herein, which may be installed in a host device;

FIG. 10 illustrates a block diagram of a transceiver adapted to transmit and receive signaling over a telecommunications network; and

FIG. 11 illustrates an embodiment network for communicating data in which the disclosed methods and systems may be implemented.

### DETAILED DESCRIPTION OF ILLUSTRATIVE EMBODIMENTS

The structure, manufacture and use of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the invention, and do not limit the scope of the invention.

Disclosed herein are methods and systems enabling the mobile device to request and/or recommend a desired tradeoff of achievable beamforming gain and achievable beam robustness with the corresponding TRP or eNB. Although the disclosed methods and systems are described below primarily with respect to using mmWave communication systems, those of ordinary skill in the art will recognize that the disclosed methods and systems are not so limited, but may also be applied to any other communication systems that utilize transceiver beamforming.

Also disclosed herein are methods and systems enabling a device to determine and send recommendations for system resource settings to a remote transmitter. In an embodiment, initiation of determining whether to recommend new system resource settings is made by the device without prompting from the remote transmitter. In an embodiment, the resource settings may include any settings that impact the ability of the device to correctly receive a signal from the remote transmitter or that affects channel quality, received signal quality, signal-to-noise ratio, data rate, etc.

The disclosed methods and systems are described primarily with reference to beam width recommendations, as discussed above, the disclosed methods and systems are not so limited, but may be applied to any other network or system parameter that may be adjusted based on a device recommendation, where the device recommendation is based upon measurements and data that are known or available to the device, but may not be known or available to the remote transmitter without feedback from the device. Also, the disclosed systems and methods are described primarily with reference to mobile devices, but are not limited to such.

Embodiments of the disclosed methods and systems provide a number of advantages over currently available wireless communication systems. For example, one or more embodiments of the disclosed methods and systems enable user equipment (UEs), i.e., mobile devices, to request and/or negotiate a desired tradeoff between the beamforming gain and the beamforming robustness based on first hand information and/or measurements that are available to the UEs, but may not be available to the transmitter. Additionally, one or more embodiments enable the TRP to understand the sensitivity requirements on the UE side and thereby allow the TRP to adapt its beamforming to compensate for the changing environments experienced by the UE due to, for example, the movement of the mobile device or others in the environment. Furthermore, embodiments of the disclosed systems and methods enable robust reception at the receiver side of a wireless communication system.

mmWave transmission may be important to future 5G standards since it enables very high data rates to be used by utilizing the wide bandwidths available in the millimeter wave band with reduced latency. Embodiments of the disclosed methods and system enable the use of wide beams to enable robust signal reception at the mobile device side for millimeter wave wireless communications in 5G HF.

As discussed above, for mobile devices, a narrow transmit beam from the TRP may be beneficial in improving the link budget. However, such a narrow transmit beam also makes the underlying beamformed link very sensitive to various environmental factors at the UE receiving transmissions from the TRP. These environmental factors may include, for example, movement of the mobile device and objects in the vicinity of the mobile device. The beam may easily get lost or degrade sharply due to the UE moving/shifting/rotating or due to objects or movement of objects between the TRP and the UE (i.e., the channel may change even if the UE is stationary due to other environmental factors). Such movement and environmental factors cannot be foreseen from the TRP side. Only the UE is situated such that it may determine an estimate on how quickly the channel is changing. Thus, disclosed herein are embodiment methods and systems that allow the UE and the TRP to agree on a certain tradeoff between the beamforming gain and the beam sensitivity to improve beam robustness. As used herein, the term beam robustness refers to the insensitivity of the channel quality relative to movement of the UE or to conditions of the surrounding environment of the UE. A robust beam allows the UE to be moved without significant degradation of the channel quality, whereas a non-robust beam may be quite sensitive to UE movement and other environmental factors that degrade the channel quality at the UE. To improve beam robustness, beamforming gain usually must be sacrificed.

However, the UE is able to access/estimate how drastic or fast the device moves or rotates. This may be accomplished through an internal sensor, such as, for example, a gyroscope, an accelerometer, and other motion sensors. The UE may also be able to estimate the channel variation due to movement of itself and/or movement or the position of nearby objects in the environment. The TRP does not have this information until the UE sends it as feedback. Thus, in an embodiment, the UE reports this information to the TRP. This may be performed explicitly by sending a number of communication parameters, such as, for example, beam width, granularity of the beam in the spatial domain, modulation and coding index offset, and transmit power offset, among others. Alternatively, the reporting may be performed implicitly. For example, the UE may decide a number of channel feedback or sounding parameters on its own, e.g., feedback granularity, feedback overhead, channel rank category, sounding granularity, and others based on its own measurements of the sensor, of the channel, and of the interference. By decoding the UE feedback or sounding, the TRP can infer the preferred communication parameters from the UE. The communication parameters inferred from the UE feedback or sounding may include, for example, beam width, granularity of the beam in the spatial domain, modulation and coding index offset, transmit power offset, etc.

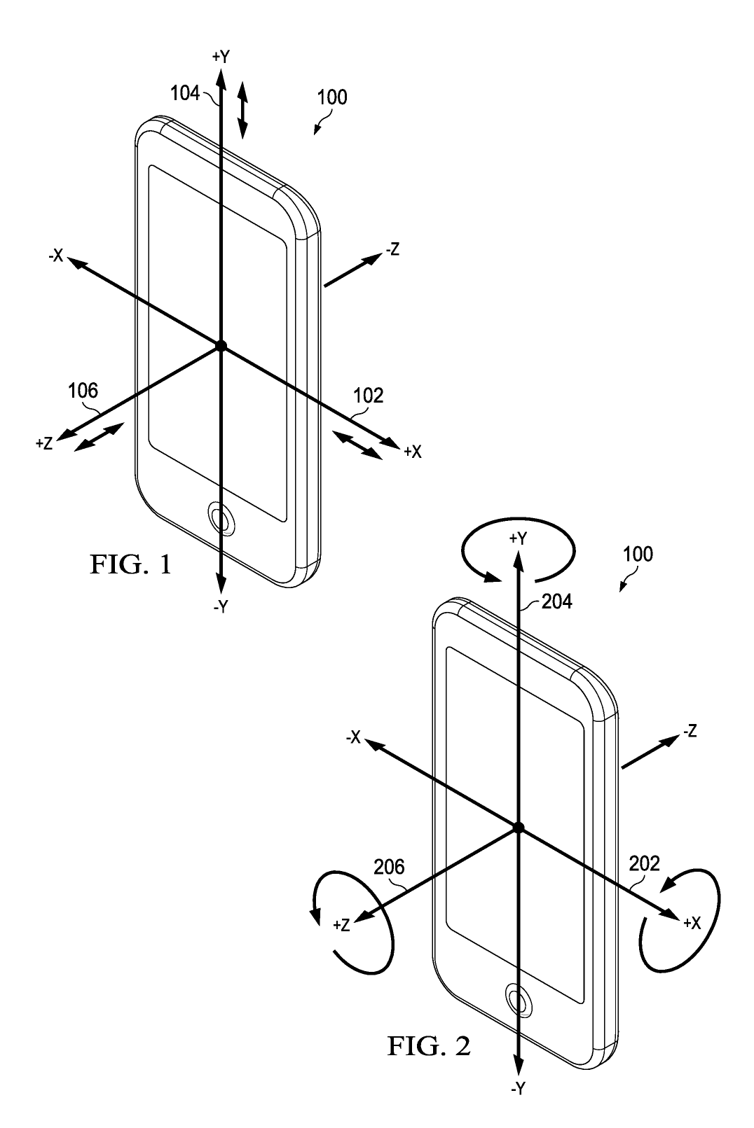

FIG. 1 is a diagram of a UE 100 illustrating translational movement of the UE 100. FIG. 2 is a diagram of the UE 100 illustrating rotational movement of the UE 100. The UE 100 may move translationally along any of the x-axis 102, the y-axis 104, and the z-axis 106 as shown in FIG. 1. The UE 100 may also rotate around any of the x-axis 102, the y-axis 104, and the z-axis as shown in FIG. 2. The movement of the UE 100 may be determined via sensors. The UE 100 may include a 3D gyroscope, a 3D accelerometer, and a magnetometer. In an embodiment, the RMS noise for the 3D gyroscope is 0.04°/sec. In an embodiment, the RMS noise for the 3 D accelerometer is 1 milli-g. In an embodiment, the UE 100 includes an output frequency sensor that is always on.

Over time, the UE 100 may learn the average angular displacement for various activities. Alternatively, average angular displacement for various activities may be provided to the UE 100. These average angular displacement values may be stored on the UE and the UE may utilize these values in determining whether to recommend a change in beam width to the TRP. The UE 100 may determine what activity is being performed by the user based on which application is open and displayed or otherwise presented to the user. Based on what application is being used, the UE may predict what the angular displacement may be and, using this information, may recommend a new beam width that is appropriate for the activity and movement of the device. For example, a user using the UE 100 to play games will likely move the UE 100 more than one who is using the UE 100 to read. Thus, the UE 100 may request a more robust beam from the TRP when the UE 100 is being used to play games. Table 1 below is an example of a table storing activities and corresponding average angular displacement.

| Activities | Angular Displacement in degrees/100 ms |
|---|---|
| Reading | 6-11 |
| Horizontal to vertical changes | 30-36 |
| Playing games | 72-80 |

In an embodiment, the UE 100 may determine the beam width preference purely based on its own capabilities and measurement. Alternatively, the TRP may provide the UE 100 with a number of choices in terms of the channel feedback or sounding parameters. The UE 100 may select one parameter out of several in performing channel feedback or sounding based on its own measurements of the sensor(s), of the channel, and of the interference.

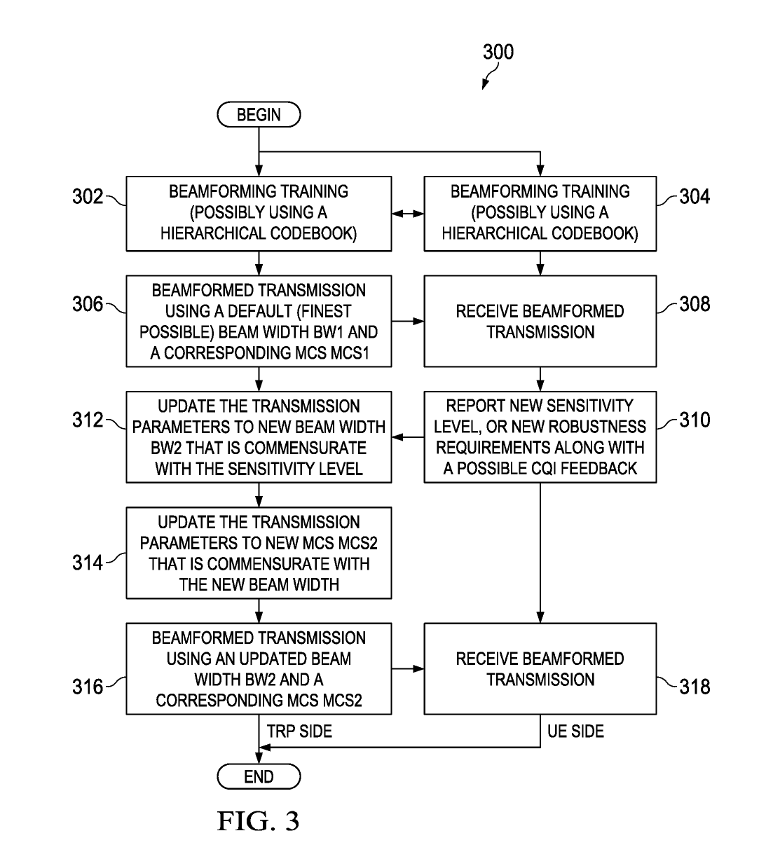

FIG. 3 is a block diagram of an embodiment of a method 300 for adjusting beam width according to UE recommendations. The method 300 begins at blocks 302 and 304 where the TRP and the UE perform beamforming training. In an embodiment, the beamforming training includes using a hierarchical codebook. The TRP and UE may perform an antenna array training to decide on a proper transmit beamforming vector and a proper receive beamforming vector.

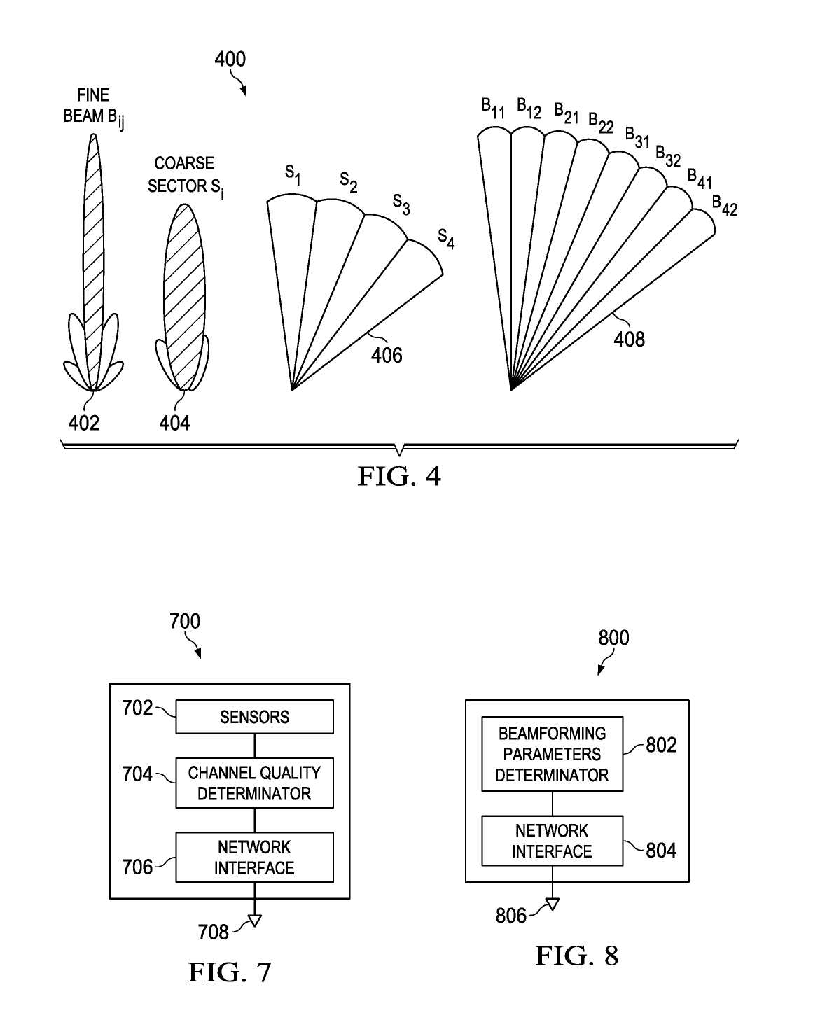

Consider the following example, with reference to FIG. 4, which is a diagram illustrating fine and course beams. The range of interest 406 may be covered by a plurality of fine beams 402 or a plurality of course beams 404. Let sectors S₁, S₂, S₃, S₄ (corresponding to the coarse sector beam 404) collectively cover the entire range of interest 406. Furthermore, let sector B₁₁, B₁₂, B₂₁, B₂₂, B₃₁, B₃₂, B₄₁, B₄₂ also collectively cover the same range of interest 406. In particular, B₁₁ and B₁₂ collectively have the same coverage as S₁. Similarly, B₂₁ and B₂₂ collectively have the same coverage as S₂, and so on and so forth. Suppose that B₂₂ is the final beamforming vector selected as a result of the hierarchical beamforming search. Then S₂ is the interim sector level vector that was used to obtain the final beamforming vector. Thus, at block 306, the TRP uses the final beamforming vector B₂₂ (by default—the finest possible beam width) with a beam width BW_1 and a corresponding modulation and coding scheme (MCS), MCS_1, to perform transmit beamforming to the UE. At block 308, the UE receives the beamformed transmission.

However, the default beamforming vector may be too sensitive due to small beam width under UE shift and/or a change in the channel between the TRP and the UE. A number of UE measurements made by the UE may trigger determination and transmission of a recommendation of a new beam width. These triggers may include UE movement, UE rotation, channel condition, interference, as well as measurements of other environmental factors such as objects in the area of the UE that interfere with signal reception and the movement of objects in the area of the UE that interfere with signal reception. Thus, at block 310, the UE may report/recommend a sensitivity level or a robustness requirement along with a potential channel quality indicator (CQI) request to the TRP. For example, suppose the recommended beam width is BW_R while the recommended CQI is CQI_R. The CQI_R is selected. BW_R may be code-book defined or non-code book defined. If the BW_R is code book defined, then the UE sends a selection from the code book. If the BW_R is not code book defined, then the UE sends back a beam width value to the TRP. In an embodiment, the recommendation may be transmitted explicitly by specifying, for example, the beam width, the granularity of the beam in the spatial domain, modulation and coding index offset, transmit power offset, etc. In an embodiment, rather than transmitting an explicit recommended beam width, the UE implicitly recommends a new beam width by transmitting information such as channel feedback, sounding parameters, etc., from which the TRP can infer the preferred communication parameters for the UE.

At block 312, the TRP updates the transmission parameters to a new beam width BW2 that is commensurate with the sensitivity level provided by the UE. The TRP may choose a beam width consistent with that recommended by the UE or it may choose a different beam width. For example, the chosen beam width BW@ may be different from the default beam width BW_1, but may also be different from the recommended BW_R in order to provide more flexibility on the TRP side. However, the chosen beam width BW_2 should provide sufficient robustness to satisfy the UE. In other embodiments, the TRP selects a beams width BW_2 that is identical to that recommended by the UE.

At block 314, the TRP updates the transmission parameters to the new MCS (i.e., MCS_2) that is commensurate with the new beam width BW_2. The TRP may choose a different MCS value than the one which was indicated by CQI_R. This may be done because the TRP has selected a different beam width than the one recommended by the UE. Therefore, if a different beam width is selected other than the one recommended by the UE, then the TRP also updates the MCS value to one that is different that was indicated by the CQI_R. The new CQI_2 is computed based on the original CQI_1 along with the original beam width, BW_1, based on the recommended CQI_R along with the recommended beam width, BW_R, and based on the final selected beam width, BW_2. Thus, CQI_2 may be expressed as a function of these parameters:

CQI_2=f(CQI_1,BW_1,CQI_R,BW_R, and BW_2)

In an example, let BW_2=BW_R and CQI_2=CQI_R. Furthermore, let the beam with width BW_1 have a gain of G_1, the beam with width BW_2 have a gain of G_2. Then, CQI_2 may be set as CQI_2=CQI_1−G_1+G_2. Furthermore, let beam with width BW_R have a gain of G_R, then CQI may be set as CQI_2=CQI_R−G_R+G_2.

At block 316, the TRP uses the updated beam width, BW_2, and corresponding MCS, MCS_2, to perform beamformed transmissions to the UE. At block 318, the UE receives the beamformed transmission from the TRP, after which, the method 300 may end.

Returning to blocks 302 and 304, in hierarchical-beam book based training, multiple codebooks may be needed on multiple layers. Generally, the top layer contains lower resolution/granularity beams (e.g., Sᵢ 404 in FIG. 4) and the higher layer contains higher resolution/granularity beams (e.g., Bᵢ 402 in FIG. 4). The beam width may correspond to a layer index in a hierarchical beam book based on the training procedure. Different beam widths, hence, correspond to a different layer in the hierarchy. In block 312, a UE may recommend the beam width/granularity (or layer index itself). Alternatively, the TRP may provide the UE with several choices in terms of the beam width/granularity and the UE may select one from these choices. These different beam widths may correspond to multiple codebooks. For example, codebook 1 has 8 codewords, each spanning 22.5 degrees whereas codebook 2 has 16 codewords, each spanning 11.25 degrees. In an embodiment, multiple codebooks form a super codebook with, for example, 24 codewords, the first 8 of which each span 22.5 degrees and the last 16 of which each span 11.25 degrees.

Since beams with different widths may correspond to beams with different resolutions/granularities, a high resolution/granularity beam may be called a fine beam or a fine sector. A low resolution/granularity beam may be called a coarse beam or a coarse sector. Beams with different widths may correspond to beams formed by different hardware or at different frequencies. A high resolution/granularity beam may be formed at high frequency and a low resolution/granularity beam may be formed at low frequency.

Beams with different widths may correspond to beams formed by different antenna elements using different methods. A high resolution/granularity beam may be formed by a large number of antenna elements whereas a low resolution/granularity beam may be formed by a low number of antenna elements.

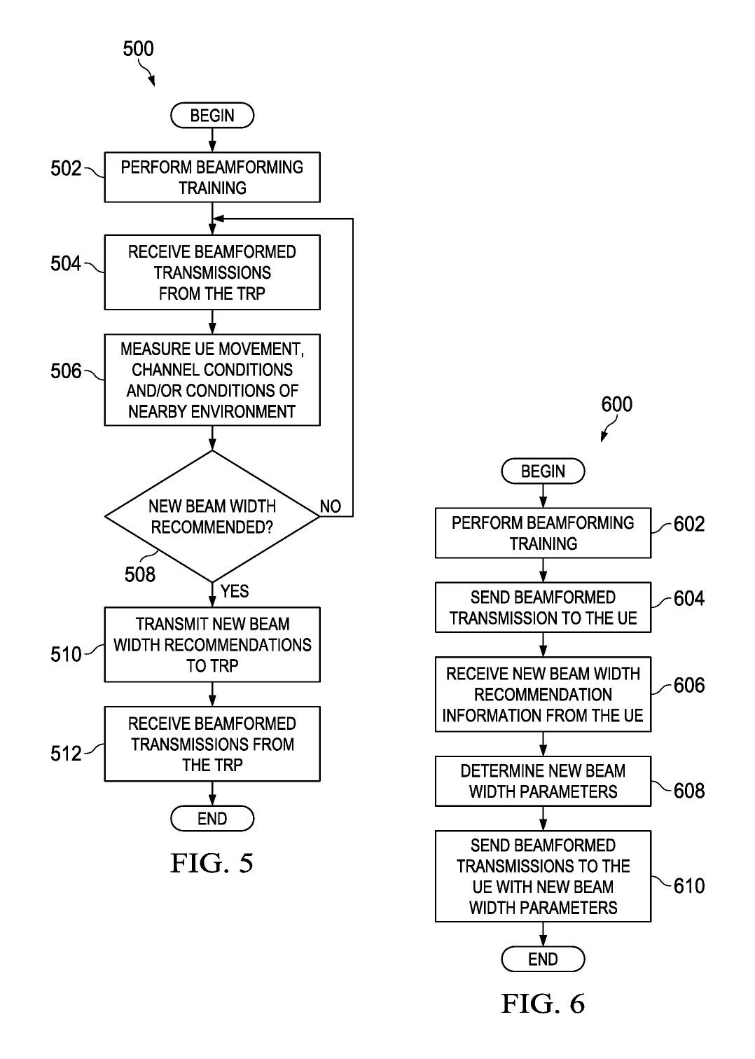

FIG. 5 is a flowchart illustrating an embodiment of a method 500 in a UE for recommending a new beam width to a TRP. The method 500 beings at block 502 where the UE performs beamforming training with the TRP. At block 504, the UE receives beamformed transmissions from the TRP. At block 506, the UE measures various parameters such as, for example, UE movement, channel conditions, interference, and/or conditions of the UE's nearby environment. At block 508, the UE determines whether a new beam width would be beneficial for beam robustness according to the various measured parameters measured in block 506. The determination may be made according to whether one of the parameters exceeds a threshold value. The threshold value may be predetermined or determined based on UE training a classifier. For example, the UE may monitor channel quality as it relates to one or more of the various parameters and maintain and determine at what point (i.e., threshold) the channel quality degrades beyond an acceptable value for a given parameter (e.g., at what angular displacement results in degradation of the channel quality below the acceptable value). The UE may train a classifier for other parameters, as well, such as lateral displacement, acceleration, speed, location, etc. The UE may also maintain a data store of activities likely to result in one of the monitored parameters exceeding a threshold value. The likelihood of activities resulting in a monitored parameter exceeding a threshold may be based on training of the UE. In an embodiment, the threshold values for each monitored parameter are beam width dependent. In an embodiment, the thresholds may be determined at the factor and preloaded into the UE. The threshold or trigger to determine whether to recommend a new beam width may be made based on the orientation and relationship of the UE to other objects detected in its environment that cause interference. Based on past usage, current activity, and/or extrapolated location and angular orientation of the UE, the UE may recommend new beam widths or parameters. Alternatively, the UE may not know where sources of interference are coming, but may determine locations and orientations of the UE at which the channel quality degrades below an acceptable threshold. The UE may monitor the location, acceleration, angular orientation, and application usage to predict if the UE may be oriented or located in a “bad” location soon or often, and based on this prediction recommend a different beam width or beam parameters.

Once the UE has determined that a new beam width or parameters may be beneficial, the UE may determine that particular recommended beam width or other beam parameter according to the current beam width and the variation in the UE parameter(s) that triggered the recommendation. The UE may specify a particular beam width based on its knowledge of where it predicts the variation in UE parameters to be. In an embodiment, the UE merely selects that next wider beam from a code book and may keep doing so until the measured channel quality stays above a defined acceptable threshold.

If, at block 508, a new beam width is not recommended, then the method 500 proceeds to block 506. If, however, at block 508, a new beam width is recommended, then the method 500 proceeds to block 510 where the UE transmits a new beam width recommendation information, either explicitly or implicitly, to the TRP. In an embodiment, the beam forming recommendations are self-initiated by the UE and not performed at the request of the TRP. At block 512, the UE receives beamformed transmissions from the TRP where the TRP performs the beamforming with updated beamforming parameters determined according to the request from the UE, after which, the method 500 ends.

FIG. 6 is a flowchart of an embodiment of a method 600 in a TRP for adjusting beam forming parameters based on recommendations from the UE. The method 600 begins at block 602 where the TRP performs beamforming training with the UE. At block 604, the TRP sends beamformed transmissions to the UE. At block 606, the TRP receives new beam width recommendation information from the UE. The information may be an explicit recommendation of a new beam width or may be an implicit recommendation for a new beam width as described above. At block 608, the TRP determines a new beam width and new beam forming parameters in response to the recommendation from the UE. At block 610, the TRP sends beamformed transmissions to the UE using the new beam width parameters, after which, the method 600 ends.

In an embodiment, the device (e.g., UE) determines a preferred resource setting or settings according to the current channel, one or more device environment parameters, or both. The preferred resource setting may be determined, for example, based on the application currently being used on the device. For example, if the user is streaming a video, then data rate may be the most important parameter and the UE may determine that a different beamforming parameter(s) other than the current beam forming parameters would result in improved data rate.

FIG. 7 is a block diagram of a UE 700. The UE includes sensors 702, a channel quality determinator 704, a network interface 706, and an antenna array 708. The sensors may include an accelerometer, a gyroscope, a magnetometer, as well as other sensors that measure the location of the UE 700 and/or the location and/or movement of other objects near the UE 702. These nearby objects may cause interference or otherwise affect the channel quality experienced by the UE. The channel quality determinator 704 uses the measurements provided by the sensors 702 as well as channel quality measurements of the channel quality received by the network interface 706 to determine whether a new beam width is recommended. The channel quality determinator 704 also determines the recommended beam width either explicitly or implicitly and transmits this determination back to a TRP through the network interface 706. The network interface 706 facilitates sending and receiving signals to/from a TRP via the attached antenna interface 708.

FIG. 8 is a block diagram of a TRP 800. The TRP 800 includes a beamforming parameters determinator 802, a network interface 804, and an antenna array 806. The beamforming parameters determinator 802 determines beamforming parameters, including beam width. The network interface 804 facilitates sending and receiving signals to/from a TRP via the attached antenna interface 806. Feedback from the UE regarding beam width is received via the network interface 804. The beamforming parameters determinator 802 determines updated beamforming parameters, including an updated beam width, based on the feedback information received from the UE.

In some embodiments, the UE and TRP negotiate a tradeoff between beamforming gain and beamforming robustness. In various embodiments, rather than a single request being sent from the UE to the TRP, the UE and TRP may exchange multiple messages until an agreed upon beam width is determined.

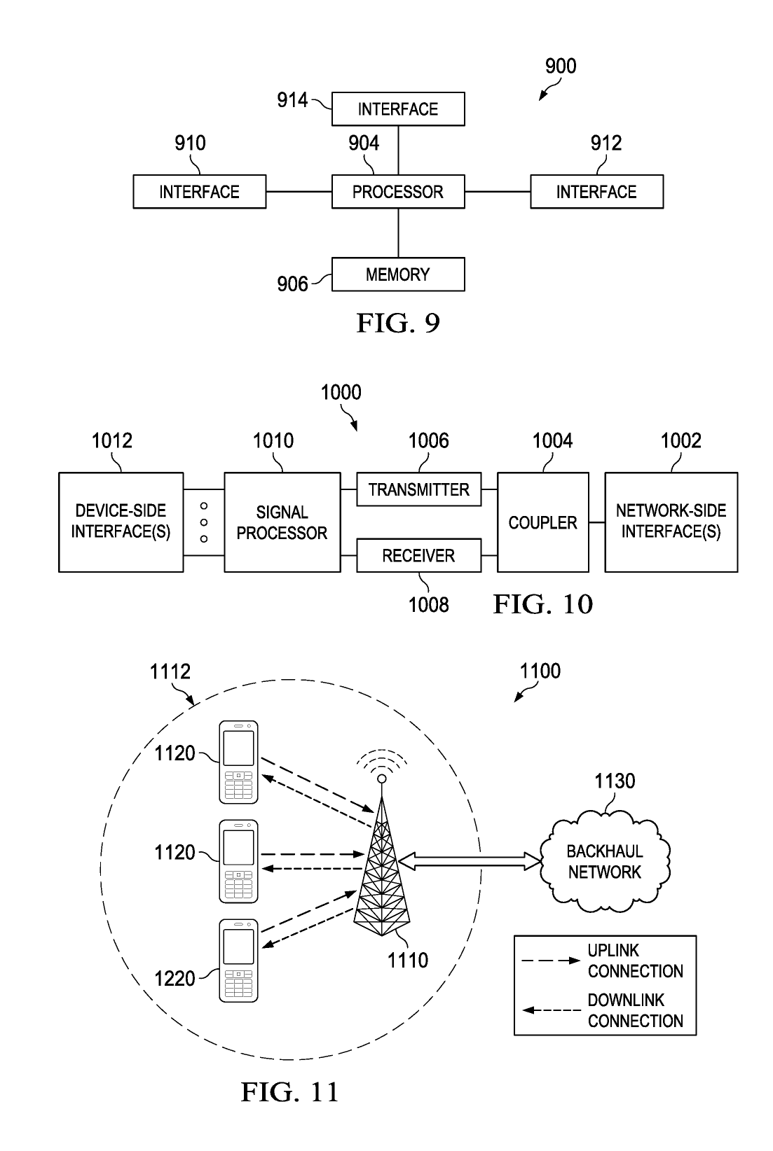

FIG. 9 illustrates a block diagram of an embodiment processing system 900 for performing methods described herein, which may be installed in a host device. As shown, the processing system 900 includes a processor 904, a memory 906, and interfaces 910-914, which may (or may not) be arranged as shown in FIG. 9. The processor 904 may be any component or collection of components adapted to perform computations and/or other processing related tasks, and the memory 906 may be any component or collection of components adapted to store programming and/or instructions for execution by the processor 904. In an embodiment, the memory 906 includes a non-transitory computer readable medium. The interfaces 910, 912, 914 may be any component or collection of components that allow the processing system 900 to communicate with other devices/components and/or a user. For example, one or more of the interfaces 910, 912, 914 may be adapted to communicate data, control, or management messages from the processor 904 to applications installed on the host device and/or a remote device. As another example, one or more of the interfaces 910, 912, 914 may be adapted to allow a user or user device (e.g., personal computer (PC), etc.) to interact/communicate with the processing system 900. The processing system 900 may include additional components not depicted in FIG. 9, such as long term storage (e.g., non-volatile memory, etc.).

In some embodiments, the processing system 900 is included in a network device that is accessing, or part otherwise of, a telecommunications network. In one example, the processing system 900 is in a network-side device in a wireless or wireline telecommunications network, such as a base station, a relay station, a scheduler, a controller, a gateway, a router, an applications server, or any other device in the telecommunications network. In other embodiments, the processing system 900 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 910, 912, 914 connects the processing system 900 to a transceiver adapted to transmit and receive signaling over the telecommunications network. FIG. 10 illustrates a block diagram of a transceiver 1000 adapted to transmit and receive signaling over a telecommunications network. The transceiver 1000 may be installed in a host device. As shown, the transceiver 1000 comprises a network-side interface 1002, a coupler 1004, a transmitter 1006, a receiver 1008, a signal processor 1010, and a device-side interface 1012. The network-side interface 1002 may include any component or collection of components adapted to transmit or receive signaling over a wireless or wireline telecommunications network. The coupler 1004 may include any component or collection of components adapted to facilitate bi-directional communication over the network-side interface 1002. The transmitter 1006 may include any component or collection of components (e.g., up-converter, power amplifier, etc.) adapted to convert a baseband signal into a modulated carrier signal suitable for transmission over the network-side interface 1002. The receiver 1008 may include any component or collection of components (e.g., down-converter, low noise amplifier, etc.) adapted to convert a carrier signal received over the network-side interface 1002 into a baseband signal. The signal processor 1010 may include any component or collection of components adapted to convert a baseband signal into a data signal suitable for communication over the device-side interface(s) 1012, or vice-versa. The device-side interface(s) 1012 may include any component or collection of components adapted to communicate data-signals between the signal processor 1010 and components within the host device (e.g., the processing system 900, local area network (LAN) ports, etc.).

The transceiver 1000 may transmit and receive signaling over any type of communications medium. In some embodiments, the transceiver 1000 transmits and receives signaling over a wireless medium. For example, the transceiver 1000 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1002 comprises one or more antenna/radiating elements. For example, the network-side interface 1002 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1000 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

FIG. 11 illustrates an embodiment network 1100 for communicating data in which the disclosed methods and systems may be implemented. The network 1100 includes an access point (AP) 1110 having a coverage area 1112, a plurality of stations (STAs) 1120, and a backhaul network 1130. In an embodiment, the AP 1110 may be implemented as transceiver 1000 shown in FIG. 10. In an embodiment, the STAs 1120 may be implemented as, for example, processing system 900 shown in FIG. 9. As used herein, the term AP may also be referred to as a TP and a TRP and the three terms may be used interchangeably throughout this disclosure. The AP may be an eNB, a gNB, or any other type of wireless transmitter/receiver. The AP 1110 may include any component capable of providing wireless access by, inter alia, establishing uplink (dashed line) and/or downlink (dotted line) connections with the STAs 1120. The STAs 1120 may include any component capable of establishing a wireless connection with the AP 1110. Examples of STAs 1120 include mobile phones, tablet computers, and laptop computers. The backhaul network 1130 may be any component or collection of components that allow data to be exchanged between the AP 1110 and a remote end (not shown). In some embodiments, the network 1100 may include various other wireless devices, such as relays, femtocells, etc.

It should be appreciated that one or more steps of the embodiment methods provided herein may be performed by corresponding units or modules. For example, a signal, packet, or beam recommendation information may be transmitted by a transmitting unit or a transmitting module. A signal, packet, beam recommendation information, or beam forming information may be received by a receiving unit or a receiving module. A signal or packet may be processed by a processing unit or a processing module. Measuring mobile device environmental parameters may be determined by a measurement unit or a measurement module. Determining beam recommendation information may be performed by a beam recommendation unit or module. The respective units/modules may be hardware, software, or a combination thereof. For instance, one or more of the units/modules may be an integrated circuit, such as field programmable gate arrays (FPGAs) or application-specific integrated circuits (ASICs).

In an embodiment, a method in a device for adjusting beam parameters at a remote transmitter includes measuring, by the device, device environmental parameters. The method also includes determining, by the device, beam recommendation information according to the device environmental parameters. The method also includes transmitting, by the device, the beam recommendation information to the remote transmitter, wherein the remote transmitter uses the beam recommendation information to adjust the beam width for transmissions to the device.

In an embodiment, a device includes a processor and a computer readable storage medium storing programming for execution by the processor. The programming includes instructions for measuring device environmental parameters. The programming also includes instructions for determining beam recommendation information according to the device environmental parameters. The programming also includes instructions for transmitting the beam recommendation information to the remote transmitter, wherein the remote transmitter uses the beam recommendation information to adjust the beam width for transmissions to the device.

In an embodiment, a non-transitory computer-readable medium storing computer instructions encoding an image, that when executed by one or more processors, cause the one or more processors to perform a plurality of steps is provided. The steps include measuring device environmental parameters. The steps also include determining beam recommendation information according to the device environmental parameters. The steps also include transmitting the beam recommendation information to the remote transmitter, wherein the remote transmitter uses the beam recommendation information to adjust the beam width for transmissions to the device.

In an embodiment, the beam recommendation information includes a recommended beam width. In an embodiment, the method, device, or computer readable storage medium includes the step of or instructions for receiving a plurality of options for a beam width, wherein the determining, by the device, beam recommendation information according to the device environmental parameters comprises selecting on of the options for the beam width. In an embodiment, the plurality of options for the beam width are received from the remote transmitter. In an embodiment, the determining beam recommendation information includes selecting a beam width corresponding to a hierarchical beam book. In an embodiment, the environmental parameters include at least one of rotation of the device, translational movement of the device, received channel quality, movement of objects proximate to the device that affect a beam signal to the device from the remote transmitter. In an embodiment, the beam recommendation information includes measured environmental parameters from which the remote transmitter determines a beam width. In an embodiment, the device is a mobile device.

In an embodiment, a method in a device for adjusting resource settings at a remote transmitter includes receiving, at the device, configuration information from a remote transmitter, the configuration information comprising multiple resource settings. The method also includes configuring the device according to the multiple resource settings. The method also includes measuring, by the device, device environmental parameters. The method also includes determining, by the device, a particular resource settings that fits best within the current channel/environment. The method also includes transmitting, by the device, the resource setting recommendation to the remote transmitter. In an embodiment, the resource settings include configuration of reference signals from the remote transmitter. In an embodiment, configuration of reference signals includes a precoder setting of the reference signal and time/frequency/code/sequence/antenna port setting of the reference signal. In an embodiment, the device is a mobile device.

In an embodiment, a device includes a processor and a computer readable storage medium storing programming for execution by the processor. The programming includes instructions for receiving multiple resource configurations from a remote transmitter. The programming also includes instructions for measuring mobile device environmental parameters. The programming also includes instructions for determining, by the mobile device, a particular resource settings that fits best within the current channel/environments. The programming also includes instructions for transmitting, by the mobile device, the resource setting recommendation to the remote transmitter. In an embodiment, the resource settings comprise configuration of reference signals from the remote transmitter. In an embodiment, the configuration of the reference signals comprises at least one of precoder setting of the reference signal or time/frequency/code/sequence/antenna port setting of the reference signal. In an embodiment, the device is a mobile device.

The following references are incorporated herein as if reproduced in their entirety:
IEEE 802.15.13c
IEEE 802.11ad
J. Wang, et al., “Beam Codebook Based Beam-Forming Protocol for Multi-Gbps Millimeter-Wave WPAN Systems”, IEEE Journal on Selected Areas in Communications, Vol. 27, No. 8, October 2009.
S. Hur, et al., “Multilevel Millimeter Wave Beam-forming for Wireless Backhaul”, IEEE Globecom Conference 2011 (Second GlobeCom 2011 Workshop on Femtocell Networks), pp. 253-257.
3GPP standard TS 136 212 V11.5.0 (2014-07)
U.S. patent application Ser. No. 14/813,736 filed 30 May 2015

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method in a device for adjusting beam parameters at a remote transmitter, comprising:
measuring, using at least one of an accelerometer, a gyroscope, a magnetometer, or a location sensor of the device, device environmental parameters;
determining, by the device, beam recommendation information according to the device environmental parameters; and
transmitting, by the device, the beam recommendation information to the remote transmitter, wherein the remote transmitter uses the beam recommendation information to adjust the beam width for transmissions to the device.

2. The method of claim 1, wherein the beam recommendation information comprises a recommended beam width.

3. The method of claim 1, further comprising:
receiving, by the device, a plurality of options for a beam width, wherein the determining, by the device, beam recommendation information according to the device environmental parameters comprises selecting one of the options for the beam width.

4. The method of claim 3, wherein the plurality of options for the beam width are received from the remote transmitter.

5. The method of claim 1, wherein the determining, by the device, beam recommendation information comprises selecting a beam width corresponding to a hierarchical beam book.

6. The method of claim 1, wherein the environmental parameters comprise at least one of rotation of the device, translational movement of the device, or movement of objects proximate to the device that affect a beam signal to the device from the remote transmitter.

7. The method of claim 1, wherein the beam recommendation information comprises measured environmental parameters from which the remote transmitter determines a beam width.

8. A device comprising:
a processor; and
a computer readable storage medium storing programming for execution by the processor, the programming including instructions for:
measuring, using at least one of an accelerometer, a gyroscope, a magnetometer, or a location sensor of the device, device environmental parameters;
determining beam recommendation information according to the device environmental parameters; and
transmitting the beam recommendation information to the remote transmitter, wherein the remote transmitter uses the beam recommendation information to adjust the beam width for transmissions to the device.

9. The device of claim 8, wherein the beam recommendation information comprises a recommended beam width.

10. The device of claim 8, wherein the programming further comprises instructions for:
receiving, by the device, a plurality of options for a beam width, wherein the determining, by the device, beam recommendation information according to the device environmental parameters comprises selecting one of the options for the beam width.

11. The device of claim 10, wherein the plurality of options for the beam width are received from the remote transmitter.

12. The device of claim 8, wherein the instructions for determining beam recommendation information comprises instructions for selecting a beam width corresponding to a hierarchical beam book.

13. The device of claim 8, wherein the environmental parameters comprise at least one of rotation of the device, translational movement of the device, or movement of objects proximate to the device that affect a beam signal to the device from the remote transmitter.

14. The device of claim 8, wherein the beam recommendation information comprises measured environmental parameters from which the remote transmitter determines a beam width.

15. A non-transitory computer-readable medium storing computer instructions encoding an image, that when executed by one or more processors, cause the one or more processors to perform the steps of:
measuring, using at least one of an accelerometer, a gyroscope, a magnetometer, or a location sensor of a device, device environmental parameters;
determining beam recommendation information according to the device environmental parameters; and
transmitting the beam recommendation information to the remote transmitter, wherein the remote transmitter uses the beam recommendation information to adjust the beam width for transmissions to the device.

16. The non-transitory computer-readable medium of claim 15, wherein the beam recommendation information comprises a recommended beam width.

17. The non-transitory computer-readable medium of claim 15, further comprising:
receiving, by the device, a plurality of options for a beam width, wherein the determining, by the device, beam recommendation information according to the device environmental parameters comprises selecting one of the options for the beam width.

18. The non-transitory computer-readable medium of claim 17, wherein the plurality of options for the beam width are received from the remote transmitter.

19. The non-transitory computer-readable medium of claim 15, wherein the determining, by the device, beam recommendation information comprises selecting a beam width corresponding to a hierarchical beam book.

20. The non-transitory computer-readable medium of claim 15, wherein the environmental parameters comprise at least one of rotation of the device, translational movement of the device, or movement of objects proximate to the device that affect a beam signal to the device from the remote transmitter.

21. The non-transitory computer-readable medium of claim 15, wherein the beam recommendation information comprises measured environmental parameters from which the remote transmitter determines a beam width.

22. A method in a device for adjusting resource settings at a remote transmitter, comprising:
receiving, at the device, configuration information from a remote transmitter, the configuration information comprising multiple resource settings;
configuring the device according to the multiple resource settings;
measuring, using at least one of an accelerometer, a gyroscope, a magnetometer, or a location sensor of the device, device environmental parameters;
determining, by the device, a preferred resource setting according to a current channel, device environmental parameters, or both; and
transmitting, by the device, a resource setting recommendation to the remote transmitter.

23. The method of claim 22, where the resource settings include configuration of reference signals from the remote transmitter.

24. The method of claim 23, where configuration of the reference signals includes at least one of a precoder setting of the reference signal, a time setting of the reference signal, a frequency setting of the reference signal, a code setting of the reference signal, a sequence setting of the reference signal, or an antenna port setting of the reference signal.

25. A device comprising:
a processor; and
a computer readable storage medium storing programming for execution by the processor, the programming including instructions for:
receiving multiple resource configurations from a remote transmitter;
measuring, using at least one of an accelerometer, a gyroscope, a magnetometer, or a location sensor of the device, device environmental parameters;
determining, by the device, a preferred resource setting according to the current channel, device environment parameter, or both; and
transmitting, by the device, the resource setting recommendation to the remote transmitter.

26. The device of claim 25, wherein the resource settings comprise configuration of reference signals from the remote transmitter.

27. The device of claim 26, wherein the configuration of the reference signals comprises at least one of precoder setting of the reference signal, a time setting of the reference signal, a frequency setting of the reference signal, a code setting of the reference signal, a sequence setting of the reference signal, or an antenna port setting of the reference signal.
